(19) United States
(12) Patent Application Publication
(10) Pub. No.: US 2026/0296572 A1
(43) Pub. Date: Oct. 1, 2026

(54) VEHICLE AERODYNAMIC CONTROL SYSTEM

(71) Applicant: HONDA MOTOR CO., LTD., Tokyo (JP)

(72) Inventors: Yuki NAKAMURA, Tokyo (JP); Shinichi UCHIYAMA, Tokyo (JP); Ryo KOYAMA, Tokyo (JP); Ryoma INOBA, Tokyo (JP); Nobuyuki TSUICHIHARA, Tokyo (JP); Takahiro IDEGUCHI, Tokyo (JP); Hidefumi NIHEI, Tokyo (JP); Yasuaki SAKAMOTO, Tokyo (JP); Yoshiteru HOSHIDA, Tokyo (JP); Fumihiko KITAMURA, Tokyo (JP)

(21) Appl. No.: 19/568,090

(22) Filed: Mar. 16, 2026

(30) Foreign Application Priority Data
Mar. 31, 2025 (JP) 2025-059885

(51) Int. Cl. B62D 35/00; B62D 37/02

(52) U.S. Cl. CPC B62D 35/005; B62D 35/007; B62D 37/02

(57) ABSTRACT

A vehicle aerodynamic control system includes a controller for controlling a front spoiler, a front diffuser, a rear spoiler, and a rear diffuser. The controller places the front spoiler and/or the rear spoiler in a deployed state and places the front diffuser and/or the rear diffuser in a retracted state when a vehicle speed is greater than a second high speed threshold and longitudinal acceleration is less than a longitudinal acceleration threshold, and places the front spoiler in a retracted state and places at least one of the front diffuser, the rear spoiler, and the rear diffuser in a deployed state when the vehicle speed is greater than the second high speed threshold and the longitudinal acceleration is equal to or greater than the longitudinal acceleration threshold.

### BACKGROUND OF THE INVENTION

### Field of the Invention

The present invention relates to a technology for controlling aerodynamics of a vehicle.

### Description of Related Art

In recent years, in order to ensure that more people have access to affordable, reliable, sustainable, and advanced energy, research and development regarding improvement of fuel efficiency of a vehicle contributing to energy efficiency have been conducted. In order to improve fuel efficiency and driving stability, an aerodynamic device is provided in a vehicle. Patent Literature 1 describes a vehicle in which a center flap and a side flap as aerodynamic devices are controlled according to a driving mode.

Patent Literature 1: US20230339553A1

### SUMMARY OF THE INVENTION

In the vehicle described in Patent Literature 1, an attitude of the aerodynamic device is determined based only on the driving mode.

The present invention has been made in view of the above points, and an object of the present invention is to provide a vehicle aerodynamic control system capable of controlling an aerodynamic device to an attitude according to a traveling state of a vehicle, and consequently contributing to energy efficiency.

In order to solve the above problem, a vehicle aerodynamic control system of the present invention includes a front spoiler; a front diffuser; a rear spoiler; a rear diffuser; and a controller for controlling the front spoiler, the front diffuser, the rear spoiler, and the rear diffuser, in which the controller places the front spoiler and/or the rear spoiler in a deployed state and places the front diffuser and/or the rear diffuser in a retracted state when a vehicle speed is greater than a threshold and longitudinal acceleration is less than a longitudinal acceleration threshold, and places the front spoiler in a retracted state and places at least one of the front diffuser, the rear spoiler, and the rear diffuser in a deployed state when the vehicle speed is greater than the threshold and the longitudinal acceleration is equal to or greater than the longitudinal acceleration threshold.

According to the present invention, the aerodynamic device can be controlled to an attitude according to the traveling state of the vehicle, and consequently, it is possible to contribute to energy efficiency.

### BRIEF DESCRIPTION OF THE DRAWINGS

FIG. 1 is a block diagram schematically showing a vehicle aerodynamic control system according to an embodiment of the present invention.

FIG. 2 is a perspective view of a vehicle to which the vehicle aerodynamic control system according to the embodiment of the present invention is applied, viewed from obliquely below.

FIG. 3 is a perspective view of a vehicle to which the vehicle aerodynamic control system according to the embodiment of the present invention is applied, viewed from obliquely above.

FIG. 4A is a cross-sectional view taken along line IV-IV of FIG. 2 schematically showing a front spoiler in a retracted state.

FIG. 4B is a cross-sectional view taken along line IV-IV of FIG. 2 schematically showing the front spoiler in a deployed state.

FIG. 5A is a cross-sectional view taken along line V-V of FIG. 2 schematically showing a front diffuser in a deployed state.

FIG. 5B is a cross-sectional view taken along line V-V of FIG. 2 schematically showing the front diffuser in a retracted state.

FIG. 6A is a perspective view schematically showing a rear spoiler in a retracted state.

FIG. 6B is a perspective view schematically showing the rear spoiler in a deployed state.

FIG. 7A is a cross-sectional view taken along line VII-VII of FIG. 2 schematically showing a rear diffuser in a deployed state.

FIG. 7B is a cross-sectional view taken along line VII-VII of FIG. 2 schematically showing the rear diffuser in a retracted state.

FIG. 8 is a table showing an example of a control method of the aerodynamic device in a sport mode.

FIG. 9 is a table showing an example of a control method of the aerodynamic device in a fuel efficiency improvement mode.

### DETAILED DESCRIPTION OF THE EMBODIMENTS

Next, an embodiment of the present invention will be described in detail with reference to the drawings as appropriate. In the reference drawings, “front and rear” indicate a longitudinal direction in a traveling direction of a vehicle, and “left and right” indicate a lateral direction (vehicle width direction) viewed from a driver's seat, respectively.

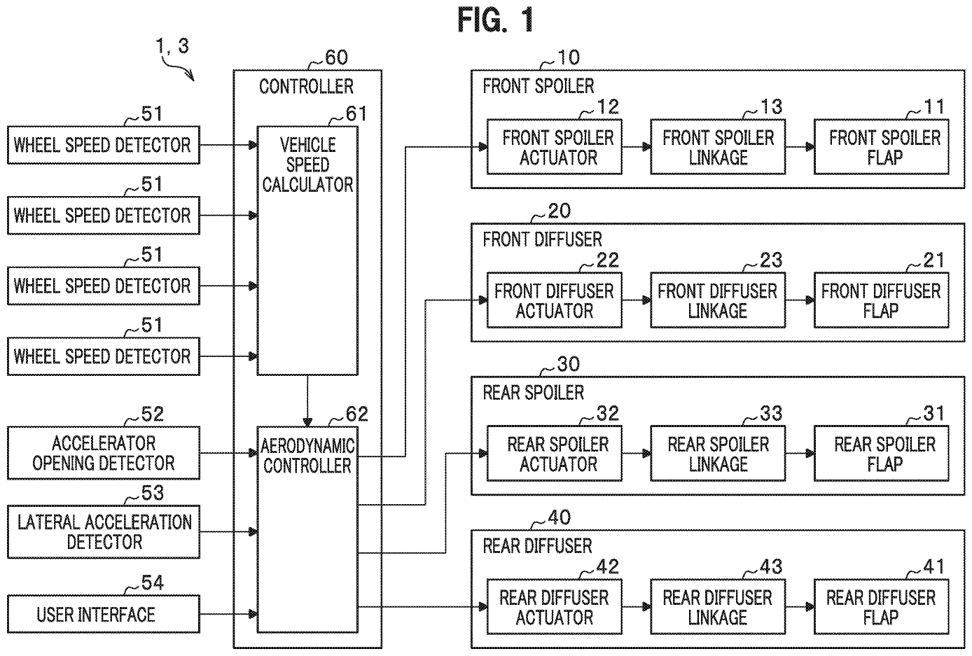

As shown in FIGS. 1, 2, and 3, a vehicle aerodynamic control system 3 applied to a vehicle 1 according to the embodiment of the present invention includes, as aerodynamic devices provided on a vehicle body 2, a front spoiler 10, a pair of left and right front diffusers 20, 20, a rear spoiler 30, and a rear diffuser 40. Further, the vehicle aerodynamic control system 2 includes a wheel speed detector 51, an accelerator opening detector 52, a lateral acceleration detector 53, a user interface 54, and a controller 60.

### Front Spoiler

As shown in FIG. 1, the front spoiler 10 includes a front spoiler flap 11, a front spoiler actuator 12, and a front spoiler linkage 13.

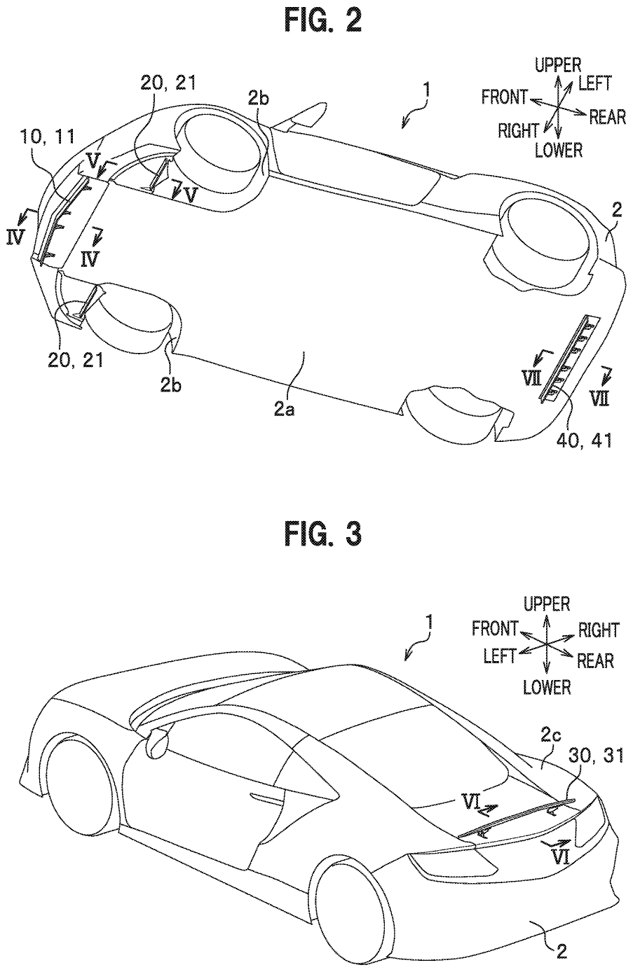

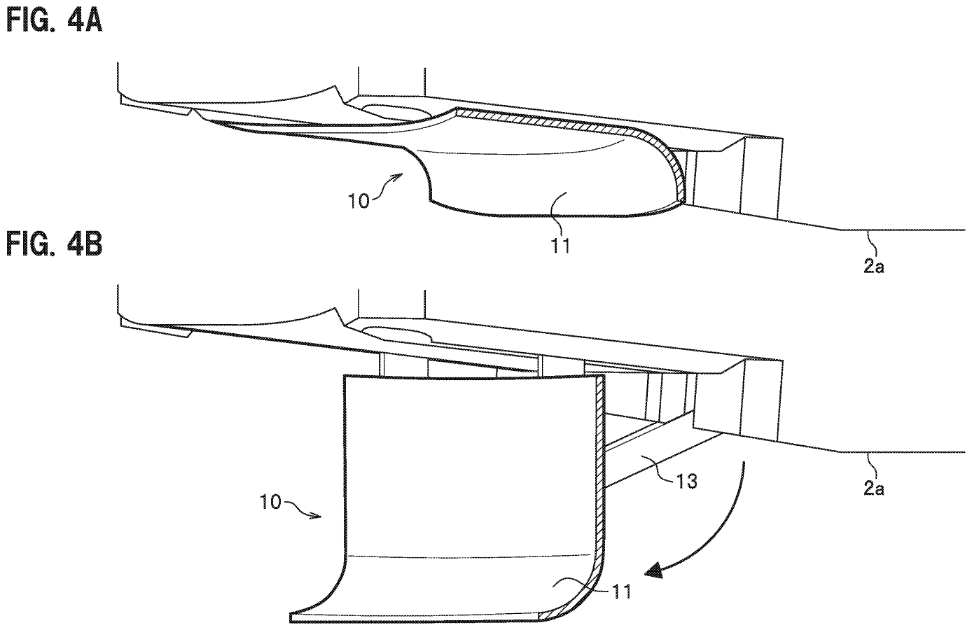

As shown in FIGS. 2 and 4, the front spoiler flap 11 is a plate-like member made of metal or resin. The front spoiler flap 11 is attached to a front end portion of a lower surface 2a of the vehicle body 2 (for example, a lower end portion of a front bumper 1a) so as to be rotatable around a lateral axis. In the present embodiment, the front spoiler flap 11 is in the retracted state in a default OFF state, and is in the deployed state in an ON state controlled by the controller 60.

As shown in FIG. 4A, the front spoiler flap 11 in the retracted state takes an attitude along the lower surface 2a of the vehicle body 2. In this attitude, a tip portion of the front spoiler flap 11 is located rearward of a base end portion serving as a rotation axis of the front spoiler flap 11. The front spoiler flap 11 in the retracted state reduces an aerodynamic value (CD value) by rectifying air inflow to a lower side of the vehicle body 2, and can improve fuel efficiency (cruising distance) as compared with the front spoiler flap 11 in the deployed state.

As shown in FIG. 4B, the front spoiler flap 11 in the deployed state takes an attitude extending downward from the lower surface 2a of the vehicle body 2. The front spoiler flap 11 in the deployed state reduces lift by suppressing air inflow to the lower side of the vehicle body 2, and improves downforce as compared with the front spoiler flap 11 in the retracted state.

As shown in FIG. 1, the front spoiler actuator 12 is configured by a motor or the like, operates based on a control signal from the controller 60 described later, and generates power for the front spoiler flap 11. The front spoiler linkage 13 is configured by a link mechanism or the like, and transmits the power generated by the front spoiler actuator 12 to the front spoiler flap 11.

### Front Diffuser

The front diffuser 20 includes a front diffuser flap 21, a front diffuser actuator 22, and a front diffuser linkage 23.

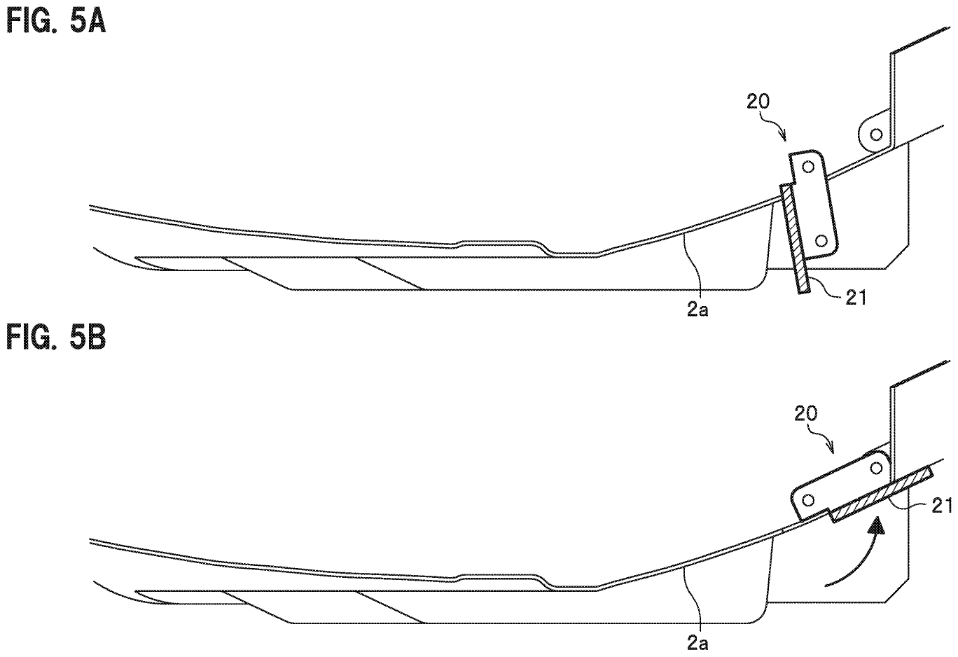

As shown in FIGS. 2 and 5, the front diffuser flap 21 is a plate-like member made of metal or resin. The front diffuser flap 21 is arranged on the lower surface 2a of the vehicle body 2 so as to be rotatable around a lateral axis with respect to a portion forward of a front lower end portion of a front wheel housing 2b. In the present embodiment, the front diffuser flap 21 is in the deployed state in a default OFF state, and is in the retracted state in an ON state controlled by the controller 60.

As shown in FIG. 5A, the front diffuser flap 21 in the deployed state takes an attitude extending downward from forward of the front lower end portion of the front wheel housing 2b on the lower surface 2a of the vehicle body 2. The front diffuser flap 21 in the deployed state rectifies airflow by suppressing air inflow to the front wheel housing 2b, and can improve fuel efficiency (cruising distance) as compared with the rear spoiler flap 21 in the retracted.

As shown in FIG. 5B, the front diffuser flap 21 in the retracted state takes an attitude along the lower surface 2a of the vehicle body 2. In this attitude, a tip portion of the front diffuser flap 21 is located rearward of a base end portion serving as a rotation axis of the front diffuser flap 21. The front diffuser flap 21 in the retracted state improves downforce as compared with the front spoiler flap 11 in the deployed state by causing air to flow into the front wheel housing 2b.

As shown in FIG. 1, the front diffuser actuator 22 is configured by a motor or the like, operates based on a control signal from the controller 60 described later, and generates power for the front diffuser flap 21. The front diffuser linkage 23 is configured by a link mechanism or the like, and transmits the power generated by the front diffuser actuator 22 to the front diffuser 21.

### Rear Spoiler

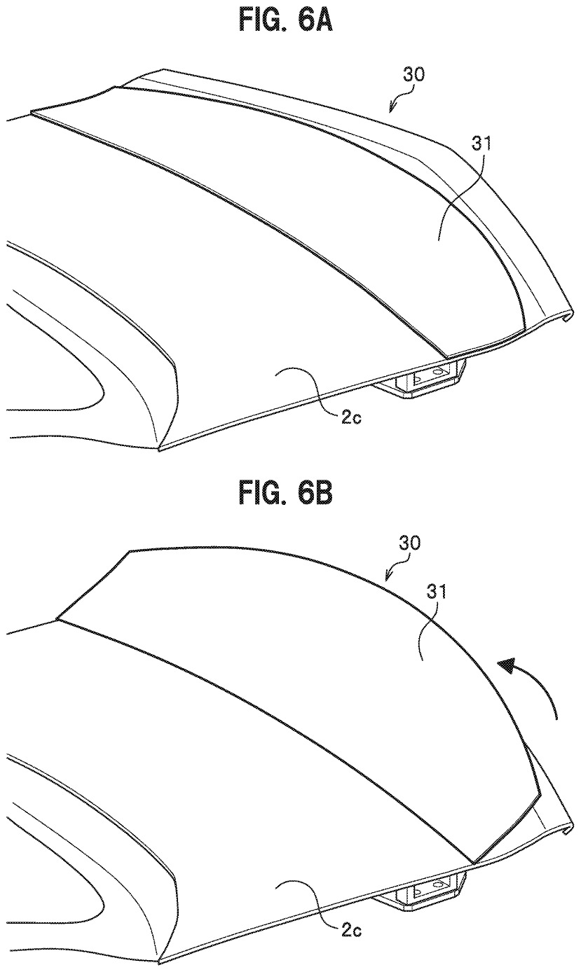

As shown in FIGS. 3 and 6, the rear spoiler 30 includes a rear spoiler flap 31, a rear spoiler actuator 32, and a rear spoiler linkage 33.

The rear spoiler flap 31 is a plate-like member made of metal or resin. The rear spoiler flap 31 is attached to a rear portion of an upper surface 2c of the vehicle body 2 so as to be rotatable around a lateral axis. In the present embodiment, the rear spoiler flap 31 is in the retracted state in a default OFF state, and is in the deployed state in an ON state controlled by the controller 60.

As shown in FIG. 6A, the rear spoiler 31 in the retracted state takes an attitude along the upper surface 2c of the vehicle body 2. In this attitude, a tip portion of the rear spoiler flap 31 is located rearward of a base end portion serving as a rotation axis of the rear spoiler flap 31. The rear spoiler flap 31 in the retracted state reduces an aerodynamic value (CD value) as compared with the rear spoiler flap 31 in the deployed state, and consequently can improve fuel efficiency (cruising distance).

As shown in FIG. 6B, the rear spoiler flap 31 in the deployed state takes an attitude extending obliquely rearward and upward from the upper surface 2c of the vehicle body 2. The rear spoiler flap 31 in the deployed state improves downforce as compared with the rear spoiler flap 31 in the retracted state.

In the present embodiment, as the deployed state, the rear spoiler flap 31 takes three states of a small deployed state, a medium deployed state, and a large deployed state in order from a smaller deployment angle to a larger deployment angle. Downforce obtained by the rear spoiler flap 31 increases as the deployment angle increases.

As shown in FIG. 1, the rear spoiler actuator 32 is configured by a motor or the like, operates based on a control signal from the controller 60 described later, and generates power for the rear spoiler flap 31. The rear spoiler linkage 32 is configured by a link mechanism or the like, and transmits the power generated by the rear spoiler actuator 32 to the rear spoiler flap 31.

### Rear Diffuser

The rear diffuser 40 includes a rear diffuser flap 41, a rear diffuser actuator 42, and a rear diffuser linkage 43.

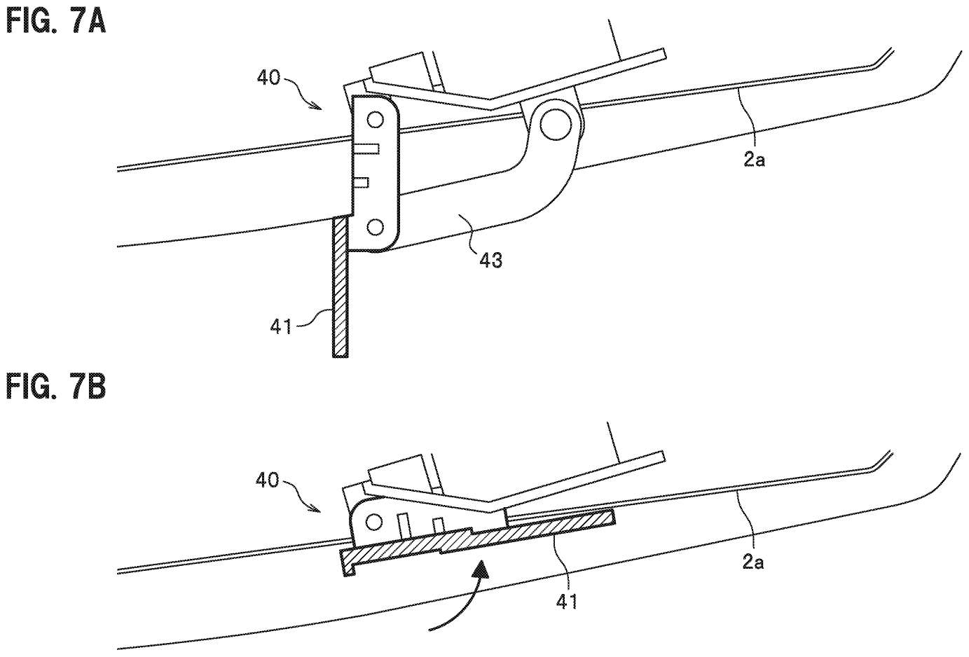

As shown in FIGS. 2 and 7, the rear diffuser flap 41 is a plate-like member made of metal or resin. The rear diffuser flap 41 is arranged on a rear portion of the lower surface 2a of the vehicle body 2 so as to be rotatable around a lateral axis. In the present embodiment, the rear diffuser flap 41 is in the deployed state in a default OFF state, and is in the retracted state in an ON state controlled by the controller 60.

As shown in FIG. 7A, the rear diffuser flap 41 in the deployed state takes an attitude extending downward from the lower surface 2a of the vehicle body 2. The rear diffuser flap 41 in the deployed state reduces an aerodynamic value (CD value) by rectifying airflow below the vehicle body 2, and can improve fuel efficiency (cruising distance) as compared with the rear diffuser flap 41 in the retracted state.

As shown in FIG. 7B, the rear diffuser flap 41 in the retracted state takes an attitude along the lower surface 2a of the vehicle body 2. In this attitude, a tip portion of the rear diffuser flap 41 is located rearward of a base end portion serving as a rotation axis of the rear diffuser flap 41. The rear diffuser flap 41 in the retracted state accelerates the airflow below the vehicle body 2 and discharges the airflow rearward, thereby improving downforce as compared with the front spoiler flap 11 in the deployed state.

As shown in FIG. 1, the rear diffuser actuator 42 is configured by a motor or the like, operates based on a control signal from the controller 60 described later, and generates power for the rear diffuser flap 41. The rear diffuser linkage 43 is configured by a link mechanism or the like, and transmits the power generated by the rear diffuser actuator 42 to the rear diffuser flap 41.

The relationship between control (OFF/ON) and state (retracted/deployed) in each of the front spoiler 10, the front diffuser 20, the rear spoiler 30, and the rear diffuser 40 is not limited to that described above, and may be reversed.

### Wheel Speed Detector

The wheel speed detector 51 is a sensor that is provided on each of wheels of the vehicle 1, detects a wheel speed, that is, a rotation speed of the wheel, and outputs a detection result to the controller 60.

### Accelerator Opening Detector

The accelerator opening detector 52 is a sensor that is provided on an accelerator pedal of the vehicle 1, detects an opening (operation amount) of the accelerator pedal, and outputs a detection result to the controller 60. The accelerator pedal is an example of an accelerator operator operated by a driver to operate a power source (internal combustion engine, motor, etc.) of the vehicle 1.

### Lateral Acceleration Detector

The lateral acceleration detector 53 is a sensor that is provided on the vehicle body of the vehicle 1, detects lateral acceleration of the vehicle 1, and outputs a detection result to the controller 60.

### User Interface

The user interface 54 is configured by a touch panel, a button, or the like provided in a vehicle interior of the vehicle 1, and outputs an operation result by the driver to the controller 60. The driver can select a driving mode of the vehicle 1 by operating the user interface 54. Examples of the driving mode include a first control mode (sport mode) for performing sport driving, and a second control mode (fuel efficiency improvement mode) for performing fuel efficiency improvement driving.

### Controller

The controller 60 is a so-called ECU (Electronic Control Unit) configured by a CPU (Central Processing Unit), a ROM (Read-Only Memory), a RAM (Random Access Memory), an input/output circuit, and the like. The controller 60 includes, as functional units, a vehicle speed calculator 61 and an aerodynamic controller 62.

The vehicle speed calculator 61 acquires the wheel speed detected by the wheel speed detector 51, calculates a speed of the vehicle 1, that is, a vehicle speed, based on the acquired wheel speed, and outputs a calculation result to the aerodynamic controller 62. Further, the vehicle speed calculator 61 is also a longitudinal acceleration calculator that calculates acceleration of the vehicle 1, that is, longitudinal acceleration, based on a temporal change in the calculated vehicle speed, and outputs a calculation result to the aerodynamic controller 62. The longitudinal acceleration takes a positive value when the vehicle speed of the vehicle 2 in a forward direction is increasing, and takes a negative value when the vehicle speed of the vehicle 2 in the forward direction is decreasing.

The aerodynamic controller 62 acquires the calculation result of the vehicle speed calculator 61, the detection result of the accelerator opening detector 62, the detection result of the lateral acceleration detector 53, and the operation result of the user interface 54. The aerodynamic controller 62 controls the front spoiler 10, the front diffuser 20, the rear spoiler 30, and the rear diffuser 40 based on the acquired various results.

### Aerodynamic Control

Subsequently, an operation example of the aerodynamic control system 2 during forward traveling of the vehicle 1 will be described in the order of the sport mode and the fuel efficiency improvement mode.

### Sport Mode

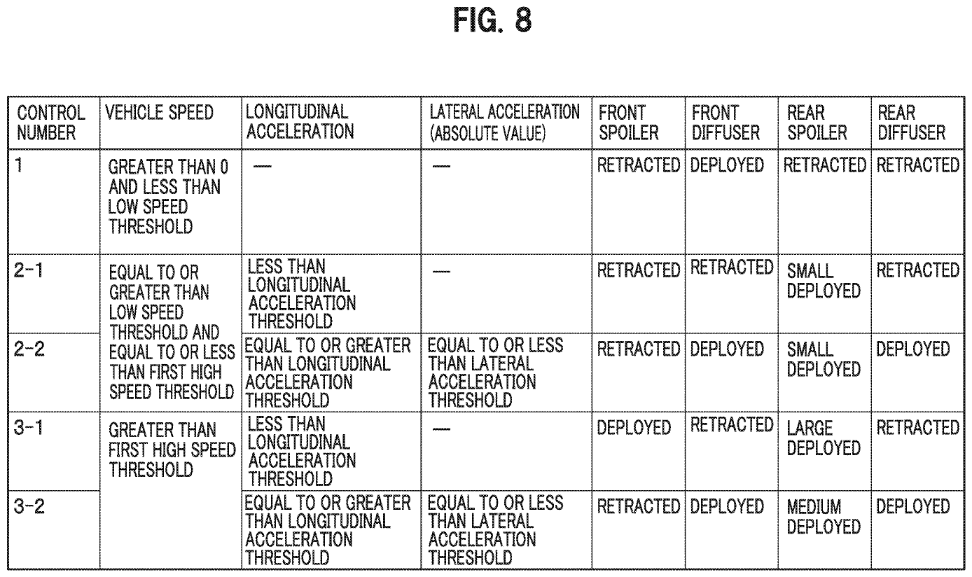

First, a case where the sport mode is selected will be described with reference to the table of FIG. 8.

### During Low Speed Driving

As shown in control number 1 of FIG. 8, when the vehicle speed is greater than 0 [km/h] and less than a low speed threshold (for example, 30 [km/h]), the aerodynamic controller 62 places the front spoiler 10, the front diffuser 20, and the rear diffuser 40 in the retracted state. Further, when the vehicle speed is greater than 0 [km/h] and less than the low speed threshold (for example, 30 [km/h]), the aerodynamic controller 62 places the rear spoiler 30 in the retracted state. Such control considers ground clearance, and can prevent the front spoiler 10, the front diffuser 20, and the rear diffuser 40 from contacting a ground.

### During First Medium Speed Driving

A control method of the aerodynamic controller 62 when the vehicle speed is equal to or greater than the low speed threshold (for example, 30 [km/h]) and equal to or less than a first high speed threshold (for example, 200 [km/h]) will be described. In this case, the aerodynamic controller 62 controls the front diffuser 20, the rear spoiler 30, and the rear diffuser 40 based on the longitudinal acceleration and the lateral acceleration.

As shown in control number 2-1 of FIG. 8, when the longitudinal acceleration is less than a longitudinal acceleration threshold (for example, 0.3 [G], that is, 2.94 [m/s²]), the aerodynamic controller 62 places the front spoiler 10, the front diffuser 20, and the rear diffuser 40 in the retracted state and places the rear spoiler 30 in the small deployed state. Such control can improve acceleration performance and turning performance of the vehicle 1 by realizing high downforce.

As shown in control number 2-2 of FIG. 8, when the longitudinal acceleration is equal to or greater than the longitudinal acceleration threshold (for example, 0.3 [G], that is, 2.94 [m/s²]) and an absolute value of the lateral acceleration is equal to or less than a lateral acceleration threshold (for example, 0.1 [G], that is, 0.98 [m/s²]), the aerodynamic controller 62 places the front spoiler 10 in the retracted state, places the front diffuser 20 and the rear diffuser 40 in the deployed state, and places the rear spoiler 30 in the small deployed state. Such control can increase a maximum speed while securing the turning performance of the vehicle 1 during acceleration at high speed when the lateral acceleration is relatively small, by realizing low CD.

### During First High Speed Driving

A control method of the aerodynamic controller 62 when the vehicle speed is greater than the first high speed threshold (for example, 200 [km/h]) will be described. In this case, the aerodynamic controller 62 controls the front spoiler 10, the front diffuser 20, the rear spoiler 30, and the rear diffuser 40 based on the longitudinal acceleration and the lateral acceleration.

As shown in control number 3-1 of FIG. 8, when the longitudinal acceleration is less than the longitudinal acceleration threshold (for example, 0.3 [G], that is, 2.94 [m/s²]), the aerodynamic controller 62 places the front spoiler 10 in the deployed state, places the front diffuser 20 and the rear diffuser 40 in the retracted state, and places the rear spoiler 30 in the large deployed state. Such control can improve the acceleration performance and the turning performance of the vehicle 1 by realizing further high downforce.

As shown in control number 3-2 of FIG. 8, when the longitudinal acceleration is equal to or greater than the longitudinal acceleration threshold (for example, 0.3 [G], that is, 2.94 [m/s²]) and the absolute value of the lateral acceleration is equal to or less than the lateral acceleration threshold (for example, 0.1 [G], that is, 0.98 [m/s²]), the aerodynamic controller 62 places the front spoiler 10 in the retracted state, places the front diffuser 20 and the rear diffuser 40 in the deployed state, and places the rear spoiler 30 in the medium deployed state. Such control can increase the maximum speed while securing the turning performance of the vehicle 1 during acceleration at high speed when the lateral acceleration is relatively small, by realizing low CD and relatively small downforce at the rear.

Note that, when the longitudinal acceleration is equal to or greater than the longitudinal acceleration threshold (for example, 0.3 [G], that is, 2.94 [m/s²]) and the absolute value of the lateral acceleration is greater than the lateral acceleration threshold (for example, 0.1 [G], that is, 0.98 [m/s²]), the aerodynamic controller 62 maintains states of the front spoiler 10, the front diffuser 20, the rear spoiler 30, and the rear diffuser 40 without changing from previous states. For example, when the absolute value of the lateral acceleration becomes greater than the lateral acceleration threshold from a case where the vehicle speed is greater than the first high speed threshold, the longitudinal acceleration is equal to or greater than the longitudinal acceleration threshold, and the absolute value of the lateral acceleration is equal to or less than the lateral acceleration threshold, the aerodynamic controller 62 maintains the state of control number 3-2 of FIG. 8. Such control can prevent a sense of discomfort given to the driver by maintaining (not changing) motion characteristics of the vehicle 2 during turning.

The aerodynamic controller 62 may be configured to place the front spoiler 10 and/or the rear spoiler 30 in the deployed state and place the front diffuser 20 and/or the rear diffuser 40 in the retracted state when the longitudinal acceleration is less than the longitudinal acceleration threshold during the first high speed driving.

The aerodynamic controller 62 may be configured to place the front spoiler 10 in the retracted state and place at least one of the front diffuser 20, the rear spoiler 30, and the rear diffuser 40 in the deployed state when the longitudinal acceleration is equal to or greater than the longitudinal acceleration threshold during the first high speed driving.

Further, the aerodynamic controller 62 may be configured to place the front spoiler 10 in the retracted state and place at least one of the front diffuser 20, the rear spoiler 30, and the rear diffuser in the deployed state when the longitudinal acceleration is equal to or greater than the longitudinal acceleration threshold and the absolute value of the lateral acceleration is less than the lateral acceleration threshold during the first high speed driving.

Further, the aerodynamic controller 62 may be configured to place the rear spoiler 30 in the deployed state during the first high speed driving, and make the deployment angle of the rear spoiler 30 when the longitudinal acceleration is equal to or greater than the longitudinal acceleration threshold (medium deployment in the embodiment) smaller than the deployment angle of the rear spoiler when the longitudinal acceleration is smaller than the longitudinal acceleration threshold (large deployment in the embodiment).

### Fuel Efficiency Improvement Driving Mode

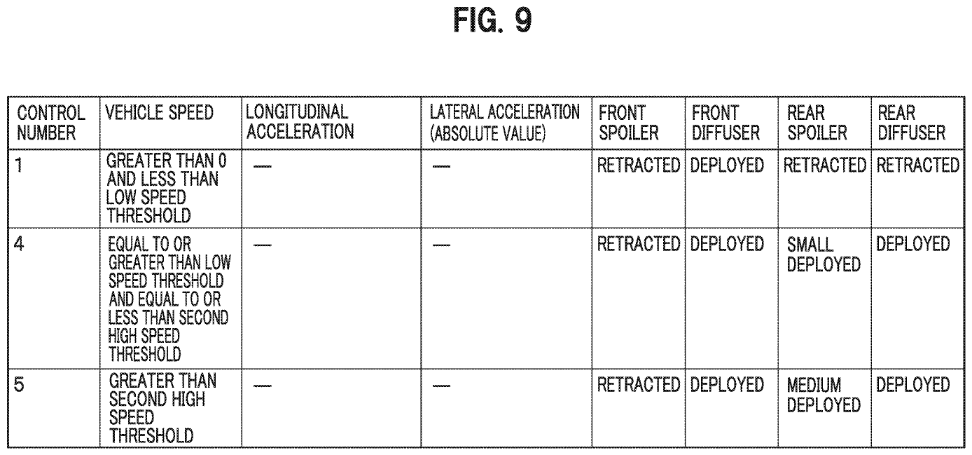

A case where the fuel efficiency improvement driving mode is selected will be described with reference to the table of FIG. 9.

### During Low Speed Driving

As shown in control number 1 of FIG. 9, when the vehicle speed is greater than 0 [km/h] and less than the low speed threshold (for example, 30 [km/h]), the aerodynamic controller 62 places the front spoiler 10, the front diffuser 20, and the rear diffuser 40 in the retracted state. Further, when the vehicle speed is less than the low speed threshold (for example, 30 [km/h]), the aerodynamic controller 62 places the rear spoiler 30 in the retracted state. Such control considers the ground clearance, and can prevent the front spoiler 10, the front diffuser 20, and the rear diffuser 40 from contacting the ground.

### During Second Medium Speed Driving

As shown in control number 4 of FIG. 9, when the vehicle speed is equal to or greater than the low speed threshold (for example, 30 [km/h]) and equal to or less than a second high speed threshold (for example, 120 [km/h]), the aerodynamic controller 62 places the front spoiler 10 in the retracted state, places the front diffuser 20 and the rear diffuser 40 in the deployed state, and places the rear spoiler 30 in the small deployed state. Such control can improve the fuel efficiency (cruising distance) of the vehicle 1 by realizing low CD (lowest CD).

### During Second High Speed Driving

As shown in control number 5 of FIG. 9, when the vehicle speed is greater than the second high speed threshold (for example, 120 [km/h]), the aerodynamic controller 62 places the front spoiler 10 in the retracted state, places the front diffuser 20 and the rear diffuser 40 in the deployed state, and places the rear spoiler 30 in the medium deployed state. Such control can improve the fuel efficiency (cruising distance) and stability of the vehicle 1 by realizing low CD and downforce capable of securing stability at the rear.

The vehicle aerodynamic control system 3 according to the embodiment of the present invention includes the front spoiler 10, the front diffuser 20, and the rear diffuser 40, and the controller 60 controlling the front spoiler 10, the front diffuser 20, and the rear diffuser 40. When the vehicle speed is less than the threshold (low speed threshold), the controller 60 places the front spoiler 10, the front diffuser 20, and the rear diffuser 40 in the retracted state, and when the vehicle speed is equal to or greater than the threshold, the controller 60 places the front spoiler 10 in the deployed state and places the front diffuser 20 and the rear diffuser 40 in the retracted state.

Therefore, the vehicle aerodynamic control system 3 can control the aerodynamic device to the attitude according to the traveling state of the vehicle. That is, the vehicle aerodynamic control system 3 places the aerodynamic device on the lower side of the vehicle body in the retracted state in a low speed range where aerodynamic control is unnecessary, and can prevent damage due to a road surface condition or the like. Further, the vehicle aerodynamic control system 3 can improve driving stability by generating downforce in a medium speed range.

When the first control mode for performing sport driving is selected, the controller 60 places the front spoiler 10, the front diffuser 20, and the rear diffuser 40 in the retracted state when the vehicle speed is less than the threshold, and places the front spoiler 10 in the deployed state and places the front diffuser 20 and the rear diffuser 40 in the retracted state when the vehicle speed is equal to or greater than the threshold.

Therefore, the vehicle aerodynamic control system 3 can suitably generate downforce in a control mode where speed increases, and improve driving stability.

When the second control mode for performing fuel efficiency improvement driving is selected, the controller 60 places the front spoiler 10 in the retracted state and places the front diffuser 20 and the rear diffuser 40 in the deployed state when the vehicle speed is equal to or greater than the threshold.

Therefore, the vehicle aerodynamic control system 3 can reduce air resistance of the vehicle body 2 in a control mode aimed at improving fuel efficiency, and improve fuel efficiency.

The vehicle aerodynamic control system 3 according to the embodiment of the present invention includes the front spoiler 10, the front diffuser 20, the rear spoiler 30, and the rear diffuser 40, and the controller 60 controlling the front spoiler 10, the front diffuser 20, the rear spoiler 30, and the rear diffuser 40. When the vehicle speed is greater than the threshold (second high speed threshold) and the longitudinal acceleration is less than the longitudinal acceleration threshold, the controller 60 places the front spoiler 10 and/or the rear spoiler 30 in the deployed state and places the front diffuser 20 and/or the rear diffuser 40 in the retracted state, and when the vehicle speed is greater than the threshold (second high speed threshold) and the longitudinal acceleration is equal to or greater than the longitudinal acceleration threshold, the controller 60 places the front spoiler 10 in the retracted state and places at least one of the front diffuser 20, the rear spoiler 30, and the rear diffuser 40 in the deployed state.

Therefore, the vehicle aerodynamic control system 3 can control the aerodynamic device to the attitude according to the traveling state of the vehicle. That is, the vehicle aerodynamic control system 3 can improve driving stability by realizing high downforce in the medium speed range, and can suitably realize high speed driving by reducing air resistance in the high speed range.

When the vehicle speed is greater than the threshold, the longitudinal acceleration is equal to or greater than the longitudinal acceleration threshold, and the absolute value of the lateral acceleration is equal to or less than the lateral acceleration threshold, the controller 60 places the front spoiler 10 in the retracted state and places at least one of the front diffuser 20, the rear spoiler 30, and the rear diffuser 40 in the deployed state.

Therefore, the vehicle aerodynamic control system 3 can suitably realize high speed driving in a safe situation by reducing air resistance when the vehicle body 2 is not unstable with respect to a request for high speed driving.

When the vehicle speed is greater than the threshold, the controller 60 places the rear spoiler 30 in the deployed state, and makes the deployment angle of the rear spoiler 30 when the longitudinal acceleration is equal to or greater than the longitudinal acceleration threshold (medium deployment in the embodiment) smaller than the deployment angle of the rear spoiler when the longitudinal acceleration is smaller than the longitudinal acceleration threshold (large deployment in the embodiment).

Therefore, the vehicle aerodynamic control system 3 can reduce air resistance while maintaining driving stability by reducing the deployment angle of the rear spoiler 30 with respect to a request for high speed driving, and can suitably realize high speed driving.

Although the embodiment of the present invention has been described above, the present invention is not limited to the above embodiment, and can be appropriately changed without departing from the gist of the present invention. For example, a detection method of the vehicle speed (vehicle body speed) and/or the longitudinal acceleration is not limited to that described above, and the vehicle aerodynamic control system 3 may be configured to include a vehicle speed detector as a sensor detecting the vehicle speed of the vehicle 1 and/or a longitudinal acceleration detector as a sensor detecting the longitudinal acceleration. Further, the aerodynamic controller 62 may use the detection result of the accelerator opening detector 52 instead of the longitudinal acceleration.

What is claimed is:

1. A vehicle aerodynamic control system comprising:
a front spoiler;
a front diffuser;
a rear spoiler;
a rear diffuser; and
a controller for controlling the front spoiler, the front diffuser, the rear spoiler, and the rear diffuser, wherein
the controller
places the front spoiler and/or the rear spoiler in a deployed state and places the front diffuser and/or the rear diffuser in a retracted state when a vehicle speed is greater than a threshold and longitudinal acceleration is less than a longitudinal acceleration threshold, and
places the front spoiler in a retracted state and places at least one of the front diffuser, the rear spoiler, and the rear diffuser in a deployed state when the vehicle speed is greater than the threshold and the longitudinal acceleration is equal to or greater than the longitudinal acceleration threshold.

2. The vehicle aerodynamic control system according to claim 1, wherein
the controller places the front spoiler in the retracted state and places at least one of the front diffuser, the rear spoiler, and the rear diffuser in the deployed state when the vehicle speed is greater than the threshold, the longitudinal acceleration is equal to or greater than the longitudinal acceleration threshold, and an absolute value of lateral acceleration is equal to or less than a lateral acceleration threshold.

3. The vehicle aerodynamic control system according to claim 1, wherein
the controller places the rear spoiler in the deployed state when the vehicle speed is greater than the threshold, and makes a deployment angle of the rear spoiler when the longitudinal acceleration is equal to or greater than the longitudinal acceleration threshold smaller than the deployment angle of the rear spoiler when the longitudinal acceleration is smaller than the longitudinal acceleration threshold.
